(19) United States
(12) Patent Application Publication
(10) Pub. No.: US 2012/0246568 A1
(43) Pub. Date: Sep. 27, 2012

(54) REAL-TIME GRAPHICAL USER INTERFACE MOVIE GENERATOR

(76) Inventor: Gregoire Alexandre Gentil, San Francisco, CA (US)

(21) Appl. No.: 13/426,574

(22) Filed: Mar. 21, 2012

Related U.S. Application Data
(60) Provisional application No. 61/466,185, filed on Mar. 22, 2011.

(51) Int. Cl. G06F 3/01

(52) U.S. Cl. 715/723

(57) ABSTRACT

An apparatus able to deliver a custom-made compressed movie stream updated in real time in response to user interaction, through a single standard interface (e.g. Universal Serial Bus (USB) or IEEE1394).

### CROSS-REFERENCE TO RELATED APPLICATIONS

Not Applicable.

### STATEMENT REGARDING FEDERALLY SPONSORED RESEARCH OR DEVELOPMENT

Not Applicable.

### REFERENCE TO SEQUENCE LISTING, A TABLE, OR A COMPUTER PROGRAM LISTING COMPACT DISK APPENDIX

Not Applicable.

### FIELD OF THE INVENTION

The present invention is generally related to video capable devices and remotely controlled systems. More specifically, this invention is related to an apparatus able to deliver a custom-made compressed movie stream updated in real time in response to user interaction, through a single standard interface (e.g. Universal Serial Bus (USB) or IEEE1394).

### BACKGROUND OF THE INVENTION

Passive displays, such as simple televisions or desktop computer displays, have been for a long time capable of displaying an external video signal generated by third-party electronic devices. Such video signals include for example analog Video Graphics Array (VGA) signals, or, more recently, digital High Definition Media Interface (HDMI) signals. This kind of display can be typically connected to a computer, which masters all the generation of these video signals, while the display itself has usually no other functionality than just properly displaying this video signal on its screen. In particular, the display has no ability to alter the incoming video signal in any way.

Lately, an internal processing unit and external generic data connectors (such as USB or IEEE1394) have completed these passive displays, allowing these new video capable devices to additionally read, decompress and play an audio or video media file stored on an external storage device connected to it. Furthermore, these video capable devices now generally provide an internally generated graphical user interface, so that one can more easily search among several folders of media files, or setup some system configuration options. Recent personal TVs typically fall into this category of video capable devices.

However, such devices don't allow any other user interface than the one installed on them, nor can they natively access any media file located in another place than an external connected storage device (e.g. on Internet or a personal network).

### SUMMARY OF THE INVENTION

The invention is directed to an electronic device, featuring a standard output connector (e.g. USB or IEEE1394), and able to provide a wide range of third-party interactive applications to be displayed on a video capable device into which it is plugged, thanks to an innovative user interface movie encapsulation method based on a real-time movie compression system.

The invention features an internal processing unit, which is used in particular to generate a custom graphical user interface (GUI), transcode any movie file accessible by the electronic device, encapsulate into one single movie stream the generated GUI and/or one or several previously transcoded movie files, compress this single movie stream and send it to a video capable device through the single standard output connector.

The invention can optionally receive data inputs, either from a remote data input device (e.g. infrared remote) or from an external data source accessible through a wireless connection. One can then configure the device to make it behave the way he wants to, as well as play any media file accessible through the wireless connection, and not only media files stored on the device.

### BRIEF DESCRIPTION OF THE DRAWINGS

FIG. 1 is a chart describing the prior art of the invention, i.e. an electronic device using its processing power to respond to user inputs and generate a standard video signal sent to and read by a standard passive display.

FIG. 2 is a chart describing another example of the prior art of the invention, i.e. an external USB storage device on which is stored a media file, exposed to a video capable device featuring an internal processing unit able to read, decompress and play said media file through a standard connection (e.g. USB or IEEE1394).

FIG. 3 is a chart describing the invention in its typical configuration, i.e. an electronic device featuring an internal processing unit, able to respond to user inputs and generate a real-time graphical user interface (GUI) encapsulated in a compressed movie stream, then sent to, decompressed and read by a video capable device.

FIG. 4 is a chart describing the invention in an additional configuration, i.e. the invention as described in FIG. 3, with an additional remotely accessed media file.

### DETAILED DESCRIPTION OF THE INVENTION

All references cited herein are incorporated by reference in their entirety as though fully set forth. Unless defined otherwise, technical and scientific terms used herein have the same meanings as commonly understood by one of ordinary skill in the art to which this invention belongs. While the foregoing written description of the invention enables one of ordinary skill to make and use what is considered presently to be the best mode thereof, those of ordinary skill will understand and appreciate the existence of variations, combinations, and equivalents of the specific embodiment, method, and examples herein. The invention should therefore not be limited by the above described embodiment, method, and examples, but by all embodiments and methods within the scope and spirit of the invention.

The present invention relates to video capable devices and remotely controlled systems, and more specifically to an apparatus able to deliver a custom-made compressed movie stream updated in real time in response to user interaction, through a single standard interface (e.g. USB or IEEE1394).

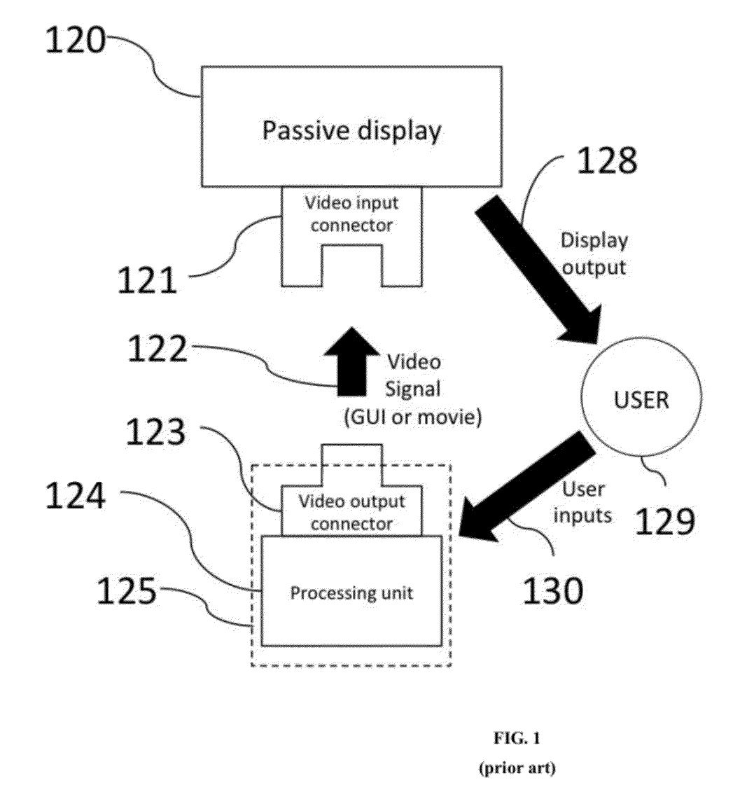

Referring now to the invention in more detail, in FIG. 1 is shown a chart describing an example of the prior art of the invention. The user 129 can interact with the external electronic device 125 (e.g. a desktop computer) thanks to standard user inputs 130 such as a computer keyboard or a computer mouse. The electronic device 125 features an internal processing unit 124, able to decompress any media file, and generate a resulting video signal 122 through its video output connector 123. The content of the video signal 122 can be of any kind, i.e. it can be generated from a media file, or from a specific graphical user interface of the operating system installed on the electronic device 125. This video signal 122 is then received by the passive display 120 through the video input connector 121, and then shown to the user with the display output 128. This example of prior art is typical of any computer able to generate a video out signal, and connected to a standard display.

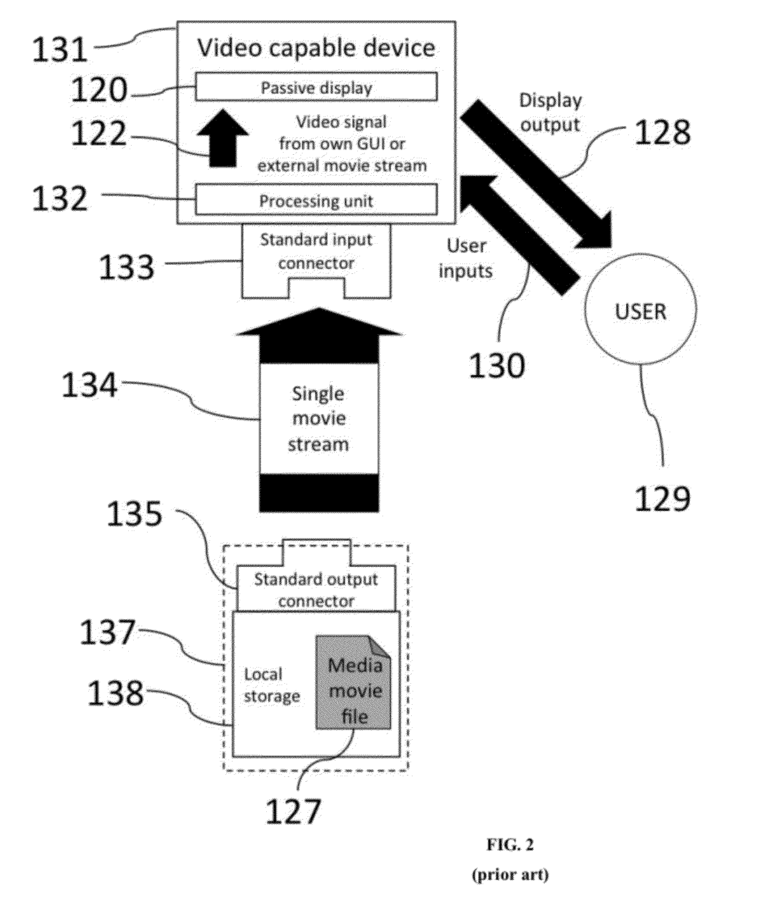

In FIG. 2 is shown a chart describing another yet more recent prior art of the invention. The passive display 120 is now part of a more complex video capable device 131, which features in addition a movie decompression processing unit 132 and an external standard input connector 133 (e.g. USB or IEEE1394). Today's personal televisions can be such video capable devices 131. When the external mass storage device 137 is connected to the video capable device 131 thanks to its standard output connector 135 (e.g. USB or IEEE1394), the video capable device 131 is able to read and decompress the movie stream 134 from the movie file 127 stored on the local storage 138 in the external mass storage device 137. In such a situation, the movie stream 134 is read and decompressed by the processing unit 132 and transmitted to the passive display 120 through the video signal 122, which then emits the corresponding display output 128 to the user. The user 129 can watch the movie file 127, as well as interact with the processing unit 132 thanks to user inputs 130 (e.g. a remote control). In this case, the processing unit 132 can generate a graphical user interface through the video signal 122 instead of a playing the movie file 127. Such a graphical user interface typically allows the user 129 to navigate within a large set of folders and files stored on the external mass storage device 137 through a friendly interface. As mentioned before, the main limitation of this kind of installation comes from the use of the sole processing unit 132 of the video capable device 131, so that any third-party user interaction methods and processes located on an external electronic device are not allowed and can not be used.

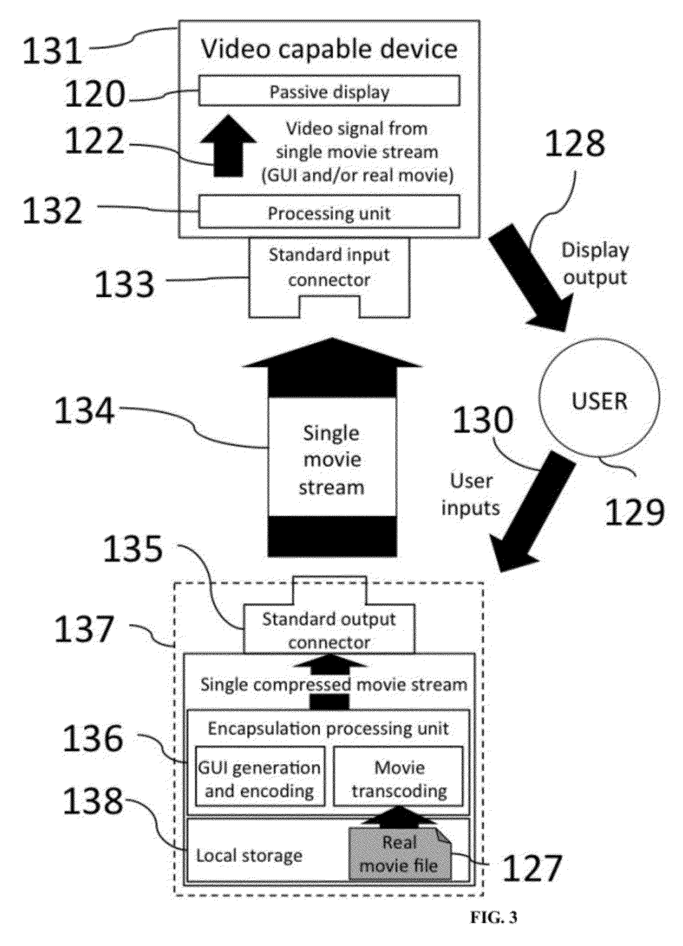

In FIG. 3 is shown a chart describing the invention in its typical configuration, i.e. the external electronic device 137, consisting of the local storage 138, the encapsulation processing unit 136 and the standard output connector 135. When the electronic device 137 is connected to the video capable device 131, the video capable device 131 has the ability to read, transcode, and play any compressed movie stream transmitted by the electronic device 137. In the prior art of invention in FIG. 2, such a compressed movie stream was simply accessed via the media movie file 127 stored in the local storage 138. In FIG. 3, the encapsulation processing unit 136 actually first read and transcodes the movie file 137, then performs a real-time movie compression before sending the movie stream 134 through its standard output connector 135. Such transcoding process can be of different complexity levels, going from simple replacement of the movie stream container, to full decompression and recompression of the movie stream. The encapsulation processing unit 136 can be configured to perform any other task (like adding real-time close captions, or incorporating short advertisement movies), just after having transcoded the movie file 127, and before sending the resulting compressed movie stream through its standard output connector 135. The movie stream 134 is then read and decompressed by the video capable device processing unit 132, and transmitted to the passive display 120 through the video signal 122, which then emits the display output 128 that the user 129 can see.

One main purpose of the invention is, as shown in FIG. 3, to allow the user 129 to send inputs 130 to the electronic device 137, instead of the video capable device processing unit 132 as in FIG. 2. Such inputs 130 can for example be generated by an infrared remote. Inputs 130 are then interpreted by the USB electronic device encapsulation processing unit 136 to typically generate a real-time graphical user interface. The encapsulation processing unit 136 then compresses such a graphical user interface into a movie stream 134, to that the video capable device 131 can read it, decompress it, and transmit it to the passive display 120 through the video signal 122, the exact same it is described in FIG. 2. That way, like in the prior art of the invention described in FIG. 2, the video capable device 131 still reads and decompresses a movie stream 134, whether this movie stream 134 was generated from a movie file 127 or from a graphical user interface by the electronic device 137. The important point of the invention is that the electronic device encapsulation processing unit 136 is updating the contents of the movie stream 134 in real time: this means that it constantly generates a custom movie from various sources as described above (i.e. a movie file 127 after having transcoded it, a custom graphical user interface, or other things like advertisement movies and close-captions), then compresses this custom movie to make available a standard movie stream 134 to the video capable device 131.

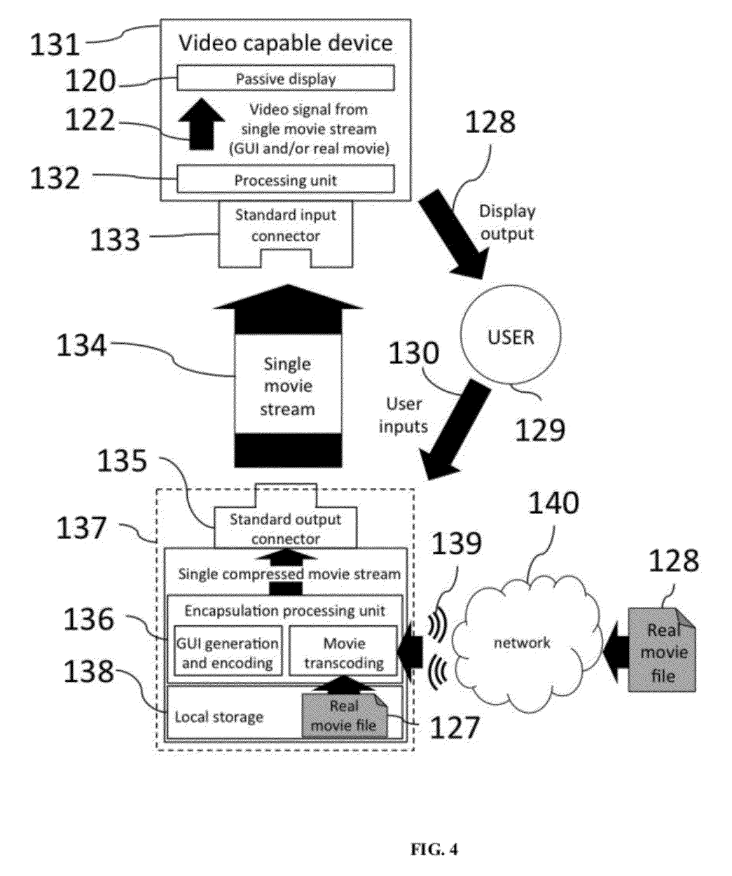

In FIG. 4 is shown a chart describing the invention in an additional configuration. As in FIG. 3, the electronic device 137 consists of the local storage 138, the encapsulation processing unit 136 and the standard output connector 135. However, the electronic device 137 has here the ability to access a remotely stored movie file 127, thanks to a wireless connection 139, being direct or carried through a specific network 140. The main purpose on the invention is here to allow the user 129 to access remotely stored personal media files over a network, as well as perform a dynamic enrichment of the contents generated by the remote data source. Such additional content can be for example contextual online advertising streams. As described in FIG. 3, the encapsulation processing unit 136 will first transcode the movie file 127, then generate a custom movie as the result of this dynamic enrichment, and compress this custom movie to create a movie stream 134 made available to the video capable device 131 through the standard output connector 135.

I claim:

1. An electronic device, comprising:
a data output connector;
a processing unit able to perform the following steps:
transcode several compressed movie streams at the same time
create in real-time a single movie stream from the combination of said movie streams
compress in real-time said single movie stream and send it through said data output connector;

2. The electronic device as recited in claim 1, wherein said processing unit is able to create a custom graphical user interface and encoding it into a single movie stream in real-time;

3. The electronic device as recited in claim 1, further including an input mechanism, where said processing unit is able to update the data within said single movie stream in reaction to inputs received through said input mechanism;

4. The electronic device as recited in claim 1, further including a remotely accessed movie stream, said remotely accessed movie stream being accessible thanks to a wireless network connection;

5. The electronic device as recited in claim 1, further including a remotely accessed movie stream, said remotely accessed movie stream being accessible thanks to a wired network connection;

6. The electronic device as recited in claim 1, further including a data storage unit, wherefrom stored movie streams can be accessed by said processing unit.
